(19) United States
(12) Patent Application Publication
(10) Pub. No.: US 2023/0134705 A1
(43) Pub. Date: May 4, 2023

(54) Vehicle Protected with Peelable Protective Film

(71) Applicant: Hitachi, Ltd., Tokyo (JP)

(72) Inventors: Nobuhito KATSUMURA, Tokyo (JP); Osamu UHARA, Tokyo (JP); Yasuhiro YAMAOKA, Tokyo (JP); Daisuke YASUMORI, Tokyo (JP)

(21) Appl. No.: 17/974,668

(22) Filed: Oct. 27, 2022

(30) Foreign Application Priority Data
Nov. 2, 2021 (JP) 2021-179863

(51) Int. Cl. C08K 3/105

(52) U.S. Cl. CPC C08K 3/105

(57) ABSTRACT

A vehicle protected with a peelable protective film having excellent moisture impermeability and moderate adhesion over a long period of time is provided. The vehicle includes a metal structure, a paint film formed on the metal structure, and a peelable protective film formed on the paint film, and the peelable protective film contains a resin and plate-like metal fillers.

### BACKGROUND OF THE INVENTION

The present invention relates to a vehicle protected with a peelable protective film.

For example, in vehicles such as automobiles and railroads, it is necessary to protect a paint on a vehicle surface from adhesion of foreign matters, sunlight, physical damage, etc. during transportation and storage from manufacture to use. As a technique for protecting such a paint, for example, a technique of forming a protective film on a paint surface using a peelable coating agent aqueous dispersion containing an acrylic copolymer emulsion has been proposed (for example, see Japanese Unexamined Pat. Application Publication No. Hei 9-286934). According to the above technology, appropriate adhesion is imparted to the protective film so that it is expected to have the effect of protecting the paint of the vehicle while achieving both adhesion during transportation and storage and peelability during use.

### SUMMARY OF THE INVENTION

When the protective film is formed using conventional techniques such as those described above, an objective of obtaining the above objective can generally be achieved if a storage period is relatively short. However, under long-term storage conditions exceeding one year (especially in a high-temperature, high-humidity environment), water vapor in the atmosphere permeates the protective film and alters a paint film, so that blisters and stains occur, and the protective film itself deteriorates due to exposure to sunlight, etc., and appropriate adhesion (adhesion and peelability) may be impaired.

An object of the present invention is to provide a vehicle protected with a peelable protective film having excellent moisture impermeability and moderate adhesion over a long period of time.

According to a preferred example of the present invention, there is provided a vehicle with a peelable protective film including a metal structure, a paint film formed on the metal structure, and a peelable protective film formed on the paint film, in which the peelable protective film contains a resin and metal plate-like fillers.

The present invention can provide a vehicle protected with a protective film having excellent moisture impermeability and moderate adhesion over a long period of time.

### BRIEF DESCRIPTION OF THE DRAWINGS

FIG. 1 is a schematic configuration diagram of a painted portion according to Example 1;

FIG. 2 is a diagram showing water permeability (relative ratio); and

FIG. 3 is a diagram showing a vehicle having the painted portion.

### DETAILED DESCRIPTION OF THE PREFERRED EMBODIMENTS

According to the present invention, there is provided a vehicle having a painted portion with a paint surface, in which the painted portion includes a metal structure, a paint film formed on the metal structure, and a peelable protective film (protective film) formed on the paint film. The above peelable protective film is placed so as to be in contact with a surface of the paint film, and contains a resin and a metal plate-like filler.

Hereinafter, examples of the present invention will be described with reference to the drawings, but the present invention is not limited only to the examples described in the drawings. Also, a configuration of the vehicle other than the painted portion is the same as the configuration of the vehicle according to a known technology, and therefore a detailed description thereof will be omitted.

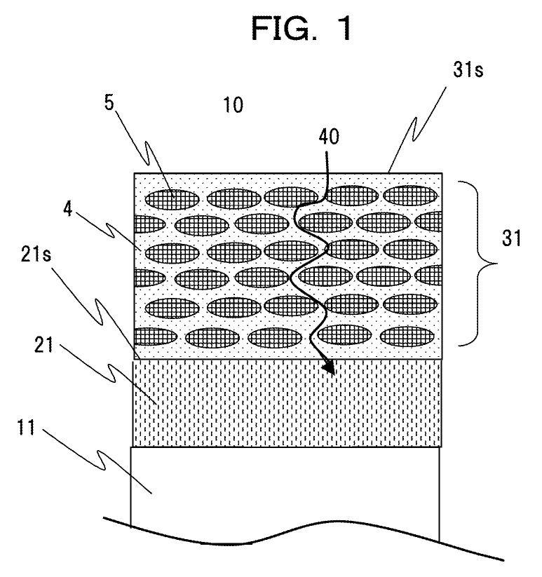

FIG. 1 is a diagram showing Example 1. Specifically, FIG. 1 is a schematic configuration diagram of a painted portion having a metal structure 11, a paint film 21, and a peelable protective film 31.

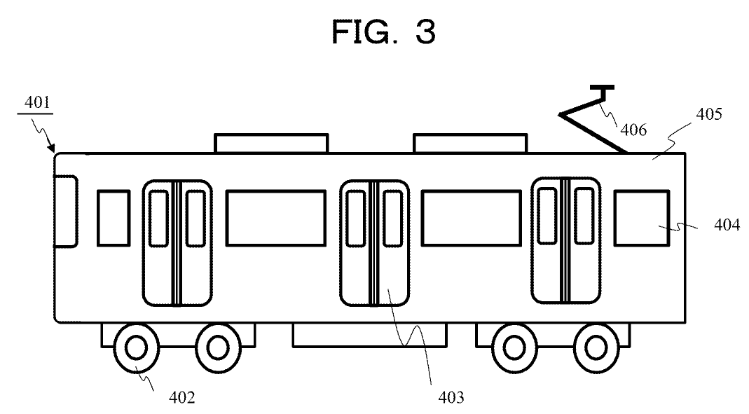

FIG. 3 is a diagram showing a vehicle 401. The vehicle 401 includes wheels 402, side sliding doors 403, windows 404, a painted portion 405, and a pantograph 406.

The vehicle 401 is a vehicle having the painted portion 405 with a painted surface, and as shown in FIG. 1, the painted portion 405 roughly includes the metal structure 11, the paint film 21, and the peelable protective film 31.

The metal structure 11 is made of, for example, a sheet metal formed by molding a metal material so as to match a shape of an object. The metal material forming the metal structure 11 is not particularly limited. Examples of the metal material include steel, aluminum alloy, stainless steel, duralumin, CFRP (carbon reinforced plastic), and the like.

The paint film 21 is a paint film provided on the metal structure 11. The paint film 21 is disposed at the outermost portion (a portion in contact with an outside air 10) when the vehicle 401 is in use (when the peelable protective film 31 is peeled off, which will be described later). The paint film 21 includes, for example, a paint having an anti-corrosion function for preventing corrosion of the metal structure 11, or a base paint such as putty applied relatively thickly for correcting an uneven shape of a surface of the metal structure 11, and a paint having a smooth and vivid color formed on the base paint. The paint film 21 may be formed by a single layer, or may be formed by multiple layers.

The paint film 21 is firmly adhered to the metal structure 11 so as not to be easily separated from the metal structure 11. A peel strength between the paint film 21 and the metal structure 11 can be configured to have a peel strength of 4 N/cm or more, for example, in a peel test using an adhesive tape peel method based on an adhesion test (cross-cut method) specified in JIS-K5600.

The thickness of the paint film 21 can be appropriately selected according to the type of the paint film 21 and the like. For example, if the paint film 21 is intended to prevent corrosion of the metal structure and improve the design, the paint film 21 may have a thickness of 10 µm to 1000 µm.

The peelable protective film 31 is a paint film provided on the paint film 21. The peelable protective film 31 is, for example, a protective film for protecting the paint film 21, and is formed so as to cover the paint film 21 when manufacturing the vehicle 401, for example.

The peelable protective film 31 is peeled off from the paint film 21 when the vehicle 401 is used. The peelable protective film 31 is disposed so as to be in contact with the surface of the paint film 21 and contains a resin and a metal plate-like filler.

As the resin 4 contained in the peelable protective film 31, for example, resin obtained by curing using an emulsion such as an acrylic copolymer can be used. As an acrylic copolymer emulsion, there are, for example, copolymer emulsions and the like of one or two or more alkyl acrylate esters and/or one or two or more alkyl methacrylate esters with one or more of vinyl monomers such as hydroxyl group-containing vinyl monomers such as vinyl acetate or hydroxyethyl acrylate, hydroxyethyl methacrylate, hydroxypropyl acrylate, hydroxypropyl methacrylate, and allyl alcohol, epoxy group-containing vinyl monomers such as glycidyl acrylate and glycidyl methacrylate, and aromatic vinyl monomers such as styrene, methyl styrene, dimethyl styrene, ethyl styrene, butyl styrene, and benzyl styrene, which are copolymerizable with the alkyl acrylate esters and/or the alkyl methacrylate esters.

With the use of the resin 4 that has been cured by using an acrylic copolymer emulsion, fillers 5 can be reliably adhered to each other. Moreover, when forming the resin 4, it is preferable to harden the resin 4 using a high temperature treatment.

The above acrylic copolymer emulsions can be used singly or in combination of two or more so as to have a glass transition temperature of 20° C. or less as the resin 4. The glass transition temperature is set to 20° C. or less, so that it is possible to keep a rubbery state and peel off from the paint film 21 while adhering to the paint film 21, and to follow a thermal expansion of the paint film 21 to prevent spontaneous peeling.

The fillers 5 are particles dispersed in the resin 4. As the shape of the fillers 5, for example, a plate-like shape can be adopted. The fillers 5 are preferably made of a material that is impermeable to moisture and does not absorb moisture. Examples of materials forming the fillers 5 include metal materials such as stainless steel, gold, and silver. Stainless steel is preferable as the material forming the fillers 5.

When the fillers 5 are made of the above material, the moisture impermeability, non-absorption, and light shielding properties can be further enhanced. Now, a reason why the peelable protective film 31 contains the fillers 5 will be described. The reason why the peelable protective film 31 contains the fillers 5 is to enhance moisture impermeability and a light shielding property.

First, a mechanism by which the peelable protective film 31 exhibits moisture impermeability will be described. It is speculated that the moisture impermeability of the peelable protective film 31 is related to a surface effect and an internal effect, which will be described below.

The surface effect is an effect of preventing external moisture (such as moisture in the outside air 10) from entering the peelable protective film 31. The peelable protective film 31 is in a state in which the resin 4 and the fillers 5 are, for example, randomly mixed. For that reason, since the fillers 5 occupy at least a part of a surface 31s of the peelable protective film 31, moisture is prevented from entering the peelable protective film 31 according to an occupying ratio, and moisture impermeability is developed in the peelable protective film 31.

The internal effect is an effect of preventing moisture that has entered the peelable protective film 31 from penetrating inside the peelable protective film 31. Since the peelable protective film 31 contains the fillers 5, the intruded moisture cannot permeate linearly toward the paint film 21 due to the obstruction of the fillers 5. For that reason, when moisture permeates toward the paint film 21, a moisture permeation path 40 through which the moisture passes becomes longer compared to linear permeation (see a solid line in the peelable protective film 31 in FIG. 1). As a result, permeation of moisture is suppressed. It is considered that the presence of the peelable protective film 31 in this way provides excellent moisture impermeability due to the above-described surface effect and internal effect.

Next, a mechanism by which the peelable protective film 31 develops light shielding properties will be described. The peelable protective film 31 contains the fillers 5, which reflect or absorb external light such as sunlight. This makes it possible to suppress the light rays from reaching the paint film 21, and to prevent deterioration of the resin 4 in the vicinity of the paint film 21 so that appropriate adhesion (adhesion and peelability) can be maintained over a long period of time.

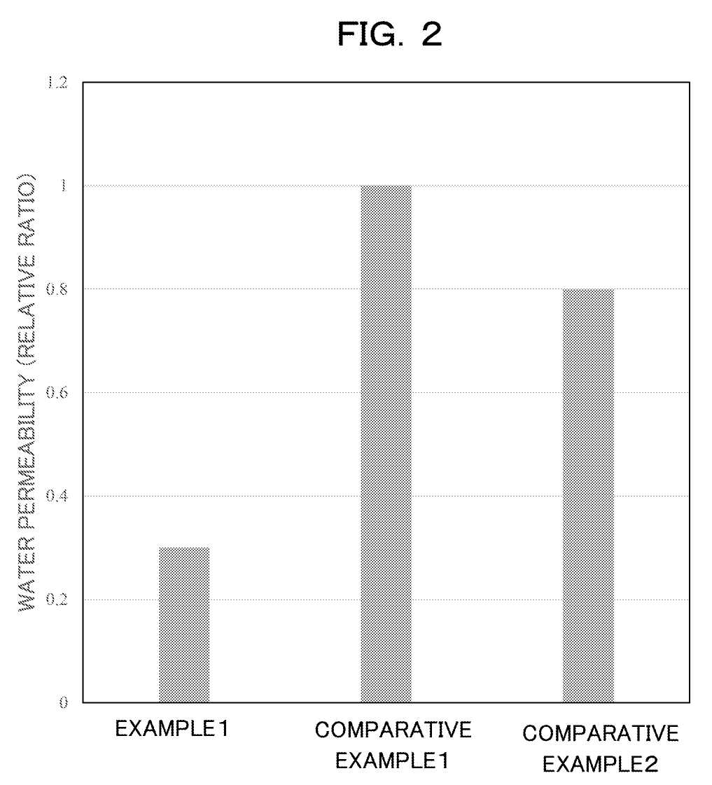

The fillers 5 are preferably plate-like particles. As shown in FIG. 2, a long-side direction of the plate-like fillers 5 generally tends to be oriented in the same direction as the surface 31s of the peelable protective film 31 (a surface opposite to the paint film 21). Therefore, the length of the moisture permeation path 40 through which moisture from the outside passes is increased, and the moisture impermeability can be improved. In such a case, it is more preferable that the plate-like fillers 5 contain particles having a long side of 30 µm or more and 100 µm or less and a short side of ⅒ or less of the long side.

A reason for such a range is that a surface of the filler 5 should have long sides, but if the length of the sides is less than 30 µm, the filler will be small and spherical in shape, resulting in poor moisture impermeability. Moreover, if the length of the side of the filler surface exceeds 100 µm, the shape becomes large and the weight becomes large. In that case, the filler sinks in the solution, and the workability deteriorates when the solution is used for coating.

The fillers whose short side is ⅒ or less of their long side allow the fillers 5 to be stacked, and the length of the moisture permeation path 40 can be reliably secured, and the moisture impermeability can be effectively improved.

The concentration of the fillers 5 in the peelable protective film 31 is preferably 1% by weight or more and 50% by weight or less. The concentration of the fillers 5 is set within the above range so that sufficient moisture impermeability can be ensured and the fillers 5 can be reliably adhered to each other. The thickness of the peelable protective film 31 is not particularly limited. The thickness of the peelable protective film 31 may be, for example, 10 µm or more and 1000 µm or less. This makes it possible to achieve both adhesion and peelability between the paint film 21 and the peelable protective film 31.

A peel strength between the paint film 21 and the peelable protective film 31 is preferably 0.1 N/10 mm or more and 1.4 N/10 mm or less. This makes it possible to achieve both adhesion and peelability between the paint film 21 and the peelable protective film 31.

A lower limit of the peel strength is preferably 0.3 N/10 mm, more preferably 0.5 N/10 mm. The lower limit of the peel strength is set to the above value so that the adhesion between the paint film 21 and the peelable protective film 31 can be enhanced.

An upper limit of the peel strength is preferably 1.4 N/10 mm, more preferably 1 N/10 mm. The upper limit of the peel strength is set to the above value so that the peelability of the peelable protective film 31 from the paint film 21 can be exhibited more reliably.

As for a mode of peeling off the peelable protective film 31 from the paint film 21, it is preferable that the peelable protective film 31 can be continuously peeled off at an interface 21s with the paint film 21. Specifically, for example, when an end of the peelable protective film 31 to be peeled off is pinched and the peelable protective film 31 is peeled off at a speed of 10 cm/sec to 10 m/sec along the peeling direction, it is preferable that the peelable protective film 31 can be continuously peeled off from the paint film 21 without tearing. As a result, the peelable protective film 31 can be smoothly peeled off without excessive effort.

Next, a method for forming the painted portion 405 of the vehicle 401 will be described. First, a metal structure 11 formed into a predetermined shape is prepared, and a paint film 21 and a peelable protective film 31 are formed on the metal structure 11 in the order of the paint film 21 and the peelable protective film 31.

As a method for forming the paint film 21, a known technique can be appropriately applied according to its configuration (type, function, etc.). As a method for forming the peelable protective film 31, for example, the paint film 21 is coated with a composition containing a polymer (or a polymer alone, or a polymer and a curing agent) used for forming the peelable protective film 31, the fillers 5, and solvent, and heated and cured at a predetermined temperature for a predetermined time to form the peelable protective film 31.

As described above, since the painted portion 405 of the vehicle 401 has the above configuration, it is possible to maintain excellent moisture impermeability and appropriate adhesion (adhesion and peelability) over a long period of time. This makes it possible to prevent loss of adequate adhesion to the paint film 21 and prevent the paint film 21 from swelling or staining. In addition, the present invention is not limited to the configuration of the embodiment described above.

Next, Example 1 of the present invention and a comparative example will be described.

### Preparation of Painted Portion

Materials used in Example 1 and Comparative Examples will be described.

### A Metal Structure

(A Metal material: aluminum alloy (A5052), thickness: 3 mm, surface shape: flat (no steps)

### B Paint Film

(B Solution-based paint Urethane resin paint (manufactured by Nippon Paint Co., Ltd.)

### C Peelable Protective Film

(C Acrylic copolymer emulsion (alkyl acrylate ester) (manufactured by Rinley, model number: PA-2)

(C Filler: plate-like stainless steel particles (manufactured by Toyo Aluminum Co., Ltd., average particle size 60 µm)

(C Solvent: distilled water

### EXAMPLE 1

A solution-based paint (B-1) is applied onto a metal material (A-1) as a metal structure, and heat-treated at 50° C. to prepare a paint film having a thickness of 50 µm. Next, the paint film is coated with a composition containing 40 parts by weight of acrylic copolymer emulsion C-1, 40 parts by weight of filler C-2, and 60 parts by weight of solvent C-3 (peelable protective film solution). After that, a heat treatment is conducted at 50° C. for 10 minutes, and the solvent C-3 is removed by drying or the like to form an outer layer with a thickness of 250 µm (configuring a peelable protective film), and the configuration of Example 1 is obtained (see FIG. 1).

The peelable protective film of this example is a peelable protective film having a composition of 50% by weight of the resin component of the acrylic copolymer and 50% by weight of the filler C-2.

Next, Comparative Example 1 will be described.

After a composition (filler-free solution) containing 40 parts by weight of the acrylic copolymer emulsion C-1 and 60 parts by weight of the solvent C-3 has been coated on the paint film formed in the same manner as in Example 1, a heat treatment is conducted at 50° C. for 10 minutes to prepare a protective film having a thickness of 500 µm, and Comparative Example 1 is obtained.

The peelable protective film of Comparative Example 1 is a peelable protective film having a composition that does not contain the filler C-2.

Next, Comparative Example 2 will be described.

After a composition containing 40 parts by weight of acrylic copolymer emulsion C-1, 50 parts by weight of filler C-2, and 60 parts by weight of solvent C-3 has been coated on a paint film formed in the same manner as in Example 1, a heat treatment is conducted at 50° C. for 10 minutes to prepare a protective film having a thickness of 500 µm, and Comparative Example 2 is obtained.

The peelable protective film of Comparative Example 2 is a peelable protective film having a composition containing more than 50% by weight of the filler C-2.

Next, the evaluation of Example 1, Comparative Example 1, and Comparative Example 2 will be described.

Moisture impermeability and adhesion (adhesion and peelability) are evaluated, and the results are shown in FIG. 2.

### Moisture Impermeability

For each of Example 1, Comparative Example 1, and Comparative Example 2, after an accelerated test has been performed by exposing for 100 hours in an environment with a temperature of 60° C. and a humidity of 90%, moisture permeability is measured according to a moisture permeability test method (cup method) for moisture-proof packaging materials specified in JIS Z0208, and the measured value is used as an index of moisture impermeability.

FIG. 2 is a diagram showing the measurement results of water permeability (relative ratio).

As shown in FIG. 2, Example 1 has a lower water permeation rate than Comparative Example 1 by 0.7 and Comparative Example 2 by about 0.5. Therefore, Example 1 is superior to Comparative Examples 1 and 2 in water impermeability.

### Adhesion Adhesion and Peelability

For each of Example 1 and Comparative Example 2, after an accelerated test similar to the accelerated test for [moisture impermeability] has been performed, a 180° peel test is performed, and the measured value (peel strength) is used as an index of adhesion.

The peel strength of Example 1 is 0.85 N/10 mm, and when the peelable protective film is peeled off from the paint film at a speed of 10 cm/sec to 10 m/sec along a peeling direction, the peelable protective film can be peeled off continuously from the paint film without tearing, and excellent peelability is obtained.

On the other hand, in Comparative Example 2, it is difficult to peel off continuously from the paint film, and when the peelable protective film is peeled off by about 20 mm, the peelable protective film is torn off, and excellent peelability cannot be obtained.

According to this example, excellent water impermeability can be maintained over a long period of time. In addition, there can be realized a peelable protective film for the purpose of temporary protection during distribution of the product, for example, for temporary protection of the product, which is effective when the product is temporarily stored outdoors during distribution or is likely to be exposed to the outdoors, and a vehicle protected by such a peelable protective film.

What is claimed is:

1. A vehicle with a peelable protective film comprising:
a metal structure;
a paint film formed on the metal structure; and
a peelable protective film formed on the paint film,
wherein the peelable protective film contains a resin and metal plate-like fillers.

2. The vehicle protected with a peelable protective film according to claim 1, wherein a concentration of the fillers in the peelable protective film is 1% by weight or more and 50% by weight or less.

3. The vehicle protected with a peelable protective film according to claim 1, wherein the fillers are plate-shaped particles having a long side of 30 µm or more and 100 µm or less and a short side of ⅒ or less of the long side.

4. The vehicle protected with a peelable protective film according to claim 3, wherein the fillers are made of stainless steel.

5. The vehicle protected with a peelable protective film according to claim 1, wherein the resin is a polymer of methacrylate ester or acrylate ester, and has a glass transition temperature of 20° C. or less.

6. The vehicle protected with a peelable protective film according to claim 1, wherein a peel strength between the paint film and the peelable protective film is 0.1 N/10 mm or more and 1.4 N/10 mm or less.

7. A method for forming a peelable protective film on a vehicle having a metal structure and a paint film formed on the metal structure, comprising the steps of:
applying a composition containing a resin, a filler, and a solvent to the paint film; and
curing the composition to form the peelable protective film.

8. The method for forming the peelable protective film on a vehicle according to claim 7, wherein the solvent is removed by drying to form the peelable protective film.
